(19) United States
(12) Patent Application Publication
(10) Pub. No.: US 2013/0271764 A1
(43) Pub. Date: Oct. 17, 2013

(54) MEASUREMENT DEVICES AND APPARATUSES FOR SPECTROSCOPIC EXAMINATION OF SAMPLES

(71) Applicants: Joerg Margraf, Jena (DE); Nico Correns, Weimar (DE)

(72) Inventors: Joerg Margraf, Jena (DE); Nico Correns, Weimar (DE)

(73) Assignee: CARL ZEISS MICROSCOPY GMBH, Jena (DE)

(21) Appl. No.: 13/876,981

(22) PCT Filed: Sep. 30, 2011
(86) PCT No.: PCT/EP11/67100

§ 371 Date: May 16, 2013

(30) Foreign Application Priority Data
Sep. 30, 2010 (DE) 10 2010 041 749.1

(51) Int. Cl. G01J 3/28

(52) U.S. Cl. CPC G01J 3/28
USPC 356/402

(57) ABSTRACT

A measurement device for spectroscopic examination of samples comprises a cavity extending in a longitudinal direction, a first opening to face a sample, a plurality of second openings for capturing light originating from the sample and at least one third opening for coupling light into the cavity. Such a measurement device is particularly suitable for spectroscopic examinations of planar samples.

### CROSS-REFERENCE TO RELATED APPLICATIONS

This application claims the benefit of International PCT/EP2011/067100 filed Sep. 30, 2011 which claims the benefit of German Patent Application No. 10 2010 041 749.1 filed Sep. 30, 2010, the disclosures of which are incorporated herein by reference.

### BACKGROUND OF THE INVENTION

1. Technical Field

The present invention relates to measurement devices for a spectroscopic examination of samples and to apparatuses which comprise such a measurement device. In particular, the present invention relates to such measurement devices and apparatuses with which plane samples, for example glass plates, may be examined spectroscopically.

2. Background Information

Through spectroscopic examination information regarding a sample may be obtained non-destructively, for example information which characterizes the quality of a sample, for example a product. Generally, spectroscopic examinations are to be understood as examinations during which a sample is irradiated with light and the light reflected, scattered, modified and/or transmitted by the sample is evaluated. Examples for apparatuses and methods for generic spectroscopic examinations are disclosed in DE 103 24 934, DE 2006 015 269 A1, US 2005/007828 A1 or WO 2009/109307 A1.

In some situations it is desirable to examine plane samples, for example plate-formed samples, spectroscopically. An example for such an application is the examination of glass planes, for example the examination of surfaces of glass areas or of properties of coatings of such glass areas.

A first conventional apparatus for spectroscopic examination of such samples is shown in FIG. 6. In the apparatus shown in FIG. 6 a plane sample 60, for example a glass plate, is examined by a spectroscopic measurement device 61 which may for example have a light source and a spectrometer. To scan sample 60, measurement device 61 is mounted to a cross member 62 which in turn is mounted to cross members 64, 65. A cross member in the context of the present application generally is a device by means of which an element mounted to the cross member may be moved along the cross member. Such cross members may for example be realized using rails, chains, pulleys, electromotors and similar mechanical and electromechanical components, respectively.

Therefore, measurement device 61 is movable on cross member 62 as indicated by an arrow 63, and cross member 62 is movable on cross members 64 and 65 as indicated by an arrow 66. In this way, measurement device 61 may be moved across the complete sample 60 to capture measurement values at different measurement points.

The number of measurement points which may be captured during a predetermined time depends inter alia on the time which is needed to move the measurement device 61 to the different measurement points. When an apparatus as shown in FIG. 6 is employed for example for checking industrially manufactured products 60 it is desirable to obtain a throughput as high as possible, i.e. to capture a required number of measurement points on sample 60 within a time as short as possible or to capture as many measurement points as possible within a predetermined time which may for example be determined by a production speed.

In the apparatus of FIG. 6, sample 6 rests within the apparatus, for example is put into the apparatus after production. However, it is increasingly desirable to move samples through such a measurement apparatus such that such a measurement apparatus may be installed “at a production line”. This type of measurement is also referred to as inline measurement.

An example for this is shown in FIG. 7. In the apparatus of FIG. 7 a sample 70 which again may be a plane product like a glass plate, moves for example on a conveyor belt as indicated by an arrow 71. Transversely to the movement direction of sample 70 a cross member 73 is provided at which a measurement device 72 for spectroscopically measuring sample 70 is mounted. Via cross member 73, measurement device 72 may be moved as indicated by an arrow 74.

The number of measurement points which may be captured in the apparatus of FIG. 7 depends on the one hand on the speed with which via cross member 73 sample 70 may be “scanned” in the transverse direction and on the other hand on the speed of sample 70. With increasing throughputs of industrial production equipment increasingly higher sample speeds are desirable, which makes capturing of a high number of measurement points with an apparatus as shown in FIG. 7 more difficult.

Correspondingly, it is an object of the present invention to provide measurement devices and apparatuses with which a spectroscopic examination in particular of plane probes with an increased number of measurement points per time unit is possible.

### SUMMARY

According to an embodiment, a measurement device is provided, comprising: a cavity extending in a longitudinal direction,

wherein the cavity comprises at least a first opening to face a sample, a plurality of second openings arranged in the longitudinal direction to capture light originating from the sample and at least one third opening to couple light into the cavity.

Via the plurality of second openings in such a measurement device a plurality of measurement points may be captured simultaneously.

The at least one first opening in particular may comprise a slit extending in the longitudinal direction of the cavity. Via this slit, light coupled into the cavity may then be guided to the sample, and the light originating from the sample reaches the plurality of second openings via the slit. The slit may for example extend via essentially the complete length of the measurement device, for example over at least 50% of the length, at least 75% of the length or at least 80% of the length.

The at least one third opening may comprise a plurality of third openings, wherein a respective third opening may be assigned to a respective second opening.

The cavity may comprise an internal coating which comprises diffusely reflecting materials. Such a cavity may then act essentially as an Ulbricht sphere, wherein the measurement device may replace a plurality of separate Ulbricht spheres.

Optionally the cavity apart from the openings may have a constant cross section along its longitudinal direction. The specific form of the cross section is generally arbitrary.

The cavity may in particular be essentially cylindrical with an essentially circular cross section perpendicular to the longitudinal direction.

The measurement device may comprise a multi-channel spectrometer which is coupled with the plurality of second openings, for example via a free beam optic or light guiding elements like glass fibers. However, separate spectrometers for different second openings are also possible,

In an embodiment of an apparatus according to the invention for spectroscopic examination, a measurement device as described above is located transversely to a longitudinal direction of the sample. The measurement device for example may be mounted to cross members, to move the measurement device in a longitudinal direction of the sample. The measurement device may also be fixedly arranged, and/or the sample may be movable in its longitudinal direction.

With such an apparatus in particular glass plates may be examined inline.

### BRIEF DESCRIPTION OF THE DRAWINGS

In the following, the invention will be explained in more detail using embodiments referring to the attached drawings, wherein:

FIG. 1 shows an apparatus for examining a sample according to an embodiment of the invention,

FIG. 2 shows an apparatus for examining a sample according to a further embodiment of the invention,

FIG. 3 shows a perspective view of an embodiment of a measurement device according to the invention,

FIG. 4 shows as side view of the measurement device of FIG. 3,

FIG. 5 shows a cross-sectional view of the measurement device of FIGS. 3 and 4 along a line B-B of FIG. 4 with additional elements,

FIG. 6 shows an apparatus according to the prior art, and

FIG. 7 shows an apparatus according to the prior art.

### DETAILED DESCRIPTION

In the following embodiments the invention will be explained in more detail. These embodiments serve merely for illustrating the invention and are not to be construed as limiting the scope of the invention. In particular a description of an embodiment with a plurality of features is not to be construed as indicating that all those features are necessary for carrying out the invention, as other embodiments may have less features and/or alternative features. Features from different embodiments may be combined unless noted otherwise.

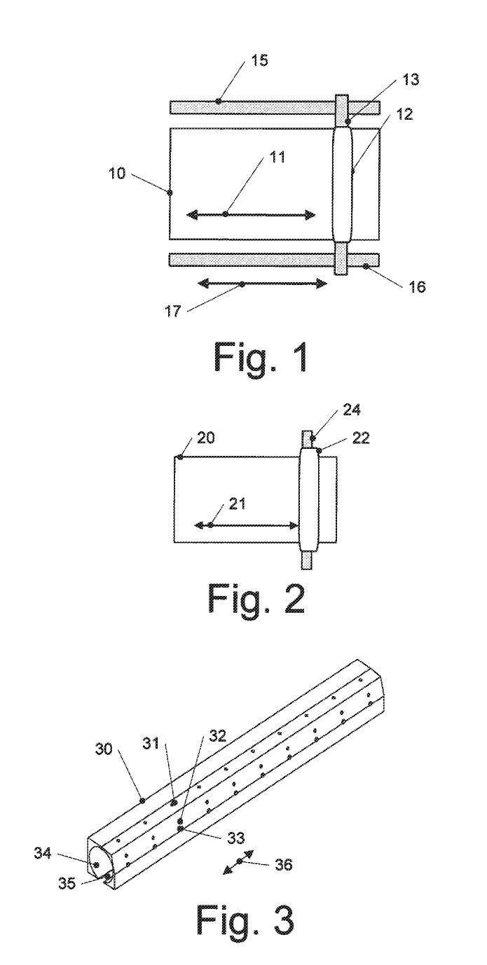

In FIG. 1, an embodiment of an apparatus according the invention for spectroscopic examination of a sample 10 is shown. In the embodiment of FIG. 1, an embodiment of a spectroscopic measurement device according to the invention is mounted to a carrier 13 such that measurement device 12 spans sample 10. Carrier 13 is mounted to cross members 15, 16, which enable movement of carrier 13 and thus of measurement device 12 in a longitudinal direction of the sample as indicated by an arrow 17, the longitudinal direction being essentially perpendicular to the direction of carrier 13.

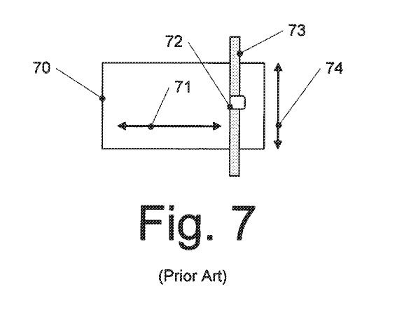

As will be explained later in more detail referring to FIGS. 3-5, measurement device 12 has a plurality of measurement openings offset in its longitudinal direction, i.e. in the direction of carrier 13, such that a plurality of measurement points may be captured simultaneously. Therefore, compared with the prior art shown in FIG. 6 or 7 no movement of measurement device 12 along carrier 13 is necessary.

Sample 10 may be a non-moving sample. In this case, movement on cross members 15, 16 serves for scanning the sample in the direction of cross members 15, 16. Cross members 15, 16 may include any suitable means for moving carrier 13, for example belts, chains, wheels or the like. In other embodiments, sample 10 as indicated by an arrow 11 may be movable in longitudinal direction of the sample, i.e. essentially perpendicular to carrier 13. In this case a movement of carrier 13 on cross members 15, 16 may serve to reduce a relative speed between measurement device 12 and sample 10 compared to a speed of sample 10 to simplify capturing more measurement points in movement direction of sample 10. This may increase measurement accuracy. The movement of carrier 13 may for example be controlled cyclically by a control unit to a predetermined relative speed to sample 10. In particular the relative speed may be controlled to be zero for measurement, such that measurement device 12 temporarily is located stationary above a measurement point.

In other embodiments, no cross members or other means for moving the measurement device are necessary in case a sample to be examined moves, for example when the sample is attached on a conveyor belt or other conveyor device. Such an embodiment is shown in FIG. 2.

In the embodiment of FIG. 2 a sample 20, in particular a planar sample like a glass plate, moves in a movement direction as indicated by an arrow 21. Transversely to the movement direction a carrier 24 is provided at which a measurement device 22 is mounted. Like the measurement device 12 of FIG. 1, measurement device 22 has a plurality of measurement openings which simultaneously enable a capturing of measuring points, i.e. a capturing and analyzing of light originating from sample 20, at a plurality of locations perpendicular to the movement direction of sample 20.

Suitable embodiments of measurement devices according to the invention will be explained in the following referring to FIGS. 3-5.

In principle it would be possible to realize a suitable measurement device using a plurality of Ulbricht spheres arranged in a row. Two or more rows of Ulbricht spheres offset with respect to each other could also be used. In such a measurement device each Ulbricht sphere may be provided with an opening to couple excitation light into the Ulbricht sphere, an opening for capturing light originating from the sample and an opening via which the excitation light coupled into the Ulbricht sphere reaches the sample after reflection on the inner wall and through which light originating from the sample may reach the opening for capturing the light.

In such an arrangement the number of possible measurement points corresponding to a number of Ulbricht spheres is limited by a possible minimal size of the Ulbricht sphere as well as possibly necessary ridges between the Ulbricht sphere. With an increasing miniaturization of the Ulbricht sphere in particular the problem emerges that the above-mentioned openings constitute an increasing portion of the sphere surface, which is detrimental to the functioning of the Ulbricht sphere.

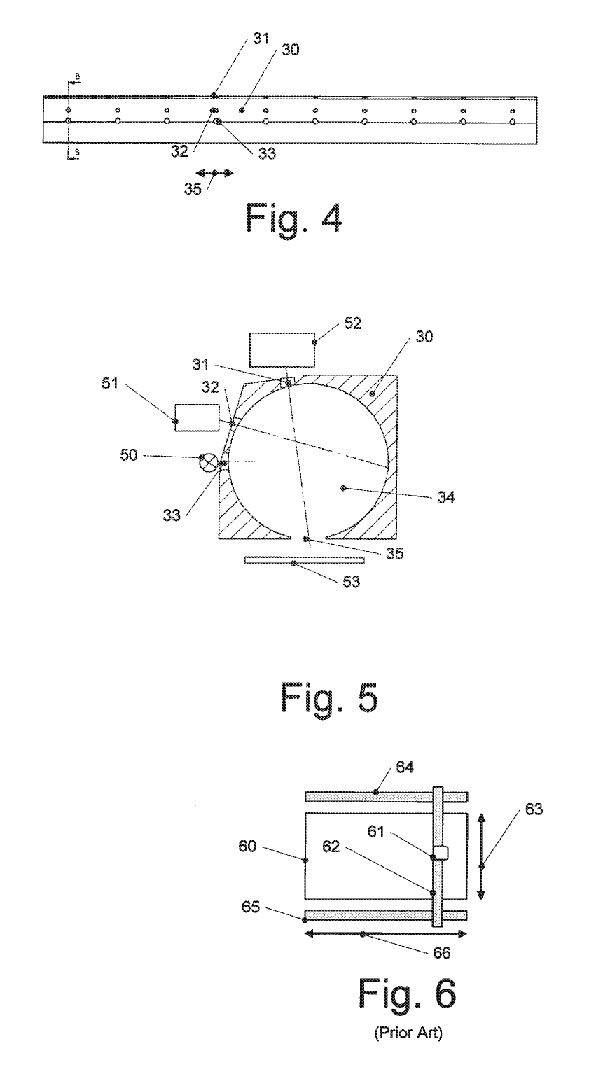

In measurement devices according to the invention a cavity extending in a longitudinal direction is provided which inter alia has a plurality of measurement openings, i.e. a plurality of openings for capturing light originating from the sample. An embodiment of such a measurement device is shown in FIGS. 3-5. FIG. 3 shows a perspective view of an embodiment of a measurement device according to the invention, FIG. 4 shows a side view of the embodiment of FIG. 3, and FIG. 5 shows a cross-sectional view along a line B-B of FIG. 4, wherein additional elements are shown in FIG. 5. The measurement device of FIGS. 3-5 may for example be employed in the apparatuses of FIG. 1 or 2, but may also be employed independently therefrom.

Measurement device 30 shown in FIGS. 3-5 has an approximately cylindrical shape cavity 35 which extends in a longitudinal direction of measurement device 30, the longitudinal direction being represented by an arrow 36 in FIGS. 3 and 4. As can be seen in particular in FIG. 5 the cross section of the cylindrical cavity is approximately circular.

In alternative embodiments (not shown) the cross section may be elliptical with two different radii. More generally, it may have the form of an arbitrary conic section. Alternatively, it may be polygonal, for example rectangular.

The cylindrical cavity 34 in the embodiment of FIG. 3 has a slit 35 which extends essentially over the complete length of the cylinder and which, when the measurement device is used, faces a sample like for example a sample 53 shown in FIG. 5.

Besides slit 35, which constitutes a first opening, a plurality of second openings 31, a plurality of third openings 33 and a plurality of fourth openings 32 are provided. The second openings 31, third openings 33 and fourth openings 32 are arranged in regular intervals in the longitudinal direction 36 in the embodiment shown, one of each of second openings 31, third openings 33 and fourth openings 32 being arranged on a common cross section perpendicular to the longitudinal direction in the embodiment shown.

The function of the various openings can best be seen from the cross-sectional view of FIG. 5.

Second openings 31 are arranged such that light originating from a sample like sample 53 may reach second openings 31 without reflection within cavity 34. Second openings 31 therefore serve as measurement openings for capturing light originating from sample 53. For analyzing this light for example a spectrometer arrangement 52 may be coupled with second openings 31. The coupling may take place via a free beam optic, for example a cylindrical optic, or via light guiding elements like glass fibers.

In an embodiment a common multi-channel spectrometer may be provided for all measurement openings, for example one channel of the multi-channel spectrometer being assigned to each measurement opening. In other embodiments separate spectrometers may be provided for different measurement openings.

Third openings 33 serve for coupling light into cavity 34, for example light originating from a light source 50. Light source 50 may for example be a laser light source, a white light source, a gas discharge lamp, a light emitting diode arrangement or any other suitable light source. For each third opening 33 a separate light source may be provided, however, it is equally possible to use a single light source and to guide the light of this light source for example via a free beam optic or with light guides to the respective third openings 33. The inner walls of cavity 34 are preferably provided with diffusely reflecting materials, for example materials like the ones used for Ulbricht spheres, such that light coupled in via third openings 33 exits after a plurality of reflections as diffusely reflected light at first opening 35 and falls on sample 53, for example to excite the same. The response to the excitation then as described above may be detected for example with spectrometer arrangement 52 via second openings 31.

Fourth openings 32 serve for observing a reference, i.e. with then light reflected from the wall of cavity 34 may for example be detected with a detector arrangement 51. Detector arrangement 51 may include a spectrometer arrangement, it may however also be a simple detector for detecting the respective intensity. Again a plurality of detector arrangements 51, for example a detector arrangement for each fourth opening 32, may be provided, or for example a multi-channel detector may be provided for all or a plurality of fourth openings 32.

It is to be noted that the measurement device of FIGS. 3-5 serves merely as an example, and diverse variations are possible. For example instead of slit 35 also a plurality of individual openings may be provided. Openings 31, 32 and 33 need not be arranged equally spaced along longitudinal direction 36, but also an arrangement with variable distances is possible, for example a higher density of openings at the edge of the measurement device, in case a sample like sample 10 of FIG. 1 or sample 20 of FIG. 2 is to be measured with more measurement points at the edge, or a higher density in the middle of the measurement device in case more measurement points are to be captured in the middle. Also it is possible to arrange openings 31, 32 and 33 not on a same cross section, respectively, but offset with respect to each other in longitudinal direction 36.

The number of openings 31, 32 and 33 does not have to correspond to the embodiment shown. For example, less third openings 33 to couple in light than second openings 31 and/or less fourth openings 32 for capturing a reference than second openings 31 may be provided.

Measurement devices according to the embodiments may be configured for various kinds of spectroscopic measurement as needed.

Furthermore, the measurement devices may be configured for transmission as well as for reflection measurements.

The measurement device shown in FIGS. 3-5 may for example be used for a color measurement in which the spectrum of light reflected from the sample is analyzed. The observation may be performed at 0° or at 8°.

In other embodiments, measurement devices may be configured for a white light interferometry, for example for a layer thickness measurement. White light interferometry is a method which uses interference of broad band light, in particular white light, the form of the signal depending on the mean wavelength, the spectrum and the coherence length of the light source used.

In other embodiments, the measurement devices may be configured for time-resolved spectroscopy, i.e. the development of the captured signal over time is examined.

In yet other embodiments, the measurement devices may be configured to perform ellipsometry measurement. In ellipsometry the change of a polarization state of light with reflection or transmission at a sample is determined. For example, linearly or circular polarized light is irradiated on the sample, which after reflection or transmission generally is elliptically polarized. The change of the polarization state in the simplest case may be described by a complex ratio ρ of reflection coefficients rₛ and rₚ, wherein rₛ is a reflection coefficient for light polarized perpendicular to the plane of incident and rₚ is a reflection coefficient for light polarized parallel to the plane of incident. Through ellipsometry measurements, for example refraction indices also of multilayer systems may be determined, whereby a layer configuration, in particular layer thicknesses, may be deduced. Compared to a pure reflection measurement, no reference measurement is necessary, as generally intensity ratios (instead of absolute intensities) are determined. For this reason also the susceptibility to intensity variations of a light source used are relatively small. Furthermore, in ellipsometry always at least two parameters are determined in a measurement.

In yet other embodiments, the measurement devices may be configured to measure scattered light.

In other embodiments, instead of spectrometers or in addition to these cameras and image processing systems may be comprised in the measurement devices, captured image being for example analyzed to find defects. For the camera(s) optionally a separate light source for illuminating the sample with different wavelengths may be provided.

In other embodiments, the measurement devices are configured to detect defects, for example in glass samples.

In other embodiments, a measurement device may be configured to measure surface properties or material properties using fluorescence spectroscopy.

Therefore, the invention is not limited to the embodiments shown.

1. A measurement device comprising:
a cavity extending in a longitudinal direction of the measurement device the cavity comprising:
at least one first opening to face the sample,
a plurality of second openings arranged in the longitudinal direction to capture light originating from the sample, and
at least one third opening to couple light into the cavity.

2. The measurement device according to claim 1, wherein the at least one first opening is comprises a slit extending in the longitudinal direction.

3. The measurement device of claim 1, wherein the cavity is essentially cylindrical with circular cross sections.

4. The measurement device of claim 1, wherein the at least one third opening comprises a plurality of third openings.

5. The measurement device of claim 4, wherein a number of the third openings corresponds to a number of the second openings.

6. The measurement device of claim 1, wherein the cavity furthermore comprises at least one fourth opening for capturing a reference.

7. The measurement device of claim 6, wherein the at least one fourth opening comprises a plurality of fourth openings, a number of the fourth openings corresponding to a number of the second openings.

8. The measurement device of claim 6, further comprising at least one detector coupled with the at least one fourth opening.

9. The measurement device of 8 of claim 1, further comprising at least one light source coupled with the at least one third opening.

10. The measurement device of claim 1, further comprising at least one spectrometer arrangement coupled with the plurality of second openings.

11. The measurement device of claim 10, wherein the spectrometer arrangement comprises a multi-channel spectrometer.

12. The measurement device of claim 10, wherein the spectrometer arrangement is coupled with the plurality of second openings via a free beam optic.

13. The measurement device of claim 10, wherein the spectrometer arrangement is coupled with the plurality of second openings via a fiber optic.

14. An apparatus for spectroscopic measurement of a sample, the sample having a longitudinal direction and a transversal direction, comprising:
a carrier arranged in the transversal direction of the sample, and
a measurement device mounted to the carrier and comprising a cavity extending in the longitudinal direction, the cavity comprising:
at least one first opening to face the sample,
a plurality of second openings arranged in the longitudinal direction to capture light originating from the sample, and
at least one third opening to couple light into the cavity.

15. The apparatus of claim 14, further comprising a device to move the carrier in the longitudinal direction of the sample.

16. The apparatus of claim 14, wherein the apparatus is configured for spectroscopic measurement of a sample moving in the longitudinal direction of the sample.

17. The apparatus of claim 14, wherein the at least one first opening comprises a slit extending in the longitudinal direction.

18. The apparatus of claim 14, wherein the cavity is essentially cylindrical with circular cross sections.

19. The apparatus of claim 14, wherein the cavity furthermore comprises at least one fourth opening for capturing a reference.

20. The apparatus of claim 14, further comprising at least one spectrometer arrangement coupled with the plurality of second openings.
